(19) United States
(12) Patent Application Publication
(10) Pub. No.: US 2022/0263176 A1
(43) Pub. Date: Aug. 18, 2022

(54) MOUNTING ARRANGEMENT FOR BATTERY CELLS TO MAINTAIN CONSTANT PRESSURE OVER THE DUTY CYCLE OF A BATTERY

(71) Applicant: Schaeffler Technologies AG & Co. KG, Herzogenaurach (DE)

(72) Inventors: Alfredo Perez Mitre JIMENEZ, Wooster, OH (US); Raymundo Juan LIEN, San Pedro Cholula (MX)

(73) Assignee: Schaeffler Technologies AG & Co. KG, Herzogenaurach (DE)

(21) Appl. No.: 17/174,468

(22) Filed: Feb. 12, 2021

(51) Int. Cl. H01M 50/244; H01M 10/04

(52) U.S. Cl. CPC H01M 50/244; H01M 10/0481

(57) ABSTRACT

A battery assembly that includes a plurality of cells and a mounting arrangement having two side plates, with the plurality of cells arranged between the two side plates with sides of the cells facing one another. At least two bolts extend between the side plates, with each bolt having a head on one end and a threaded engagement on an opposite end. The at least two bolts are configured to clamp the side plates and the cells together. For each of the bolts, a diaphragm spring is located at least one of between the head and an adjacent one of the side plates or between the threaded engagement and an adjacent one of the side plates. The diaphragm spring is configured to apply a force over an effective range of the diaphragm spring such that the side plates constant force is applied to the cells during expansion and contraction.

### FIELD OF INVENTION

The present disclosure relates to a battery holder arrangement, and more particularly to a mounting arrangement that is adapted to apply constant pressure to a plurality of stacked battery cells over a duty cycle of a battery.

### BACKGROUND

In order for batter cells to operate at peak performance and have the longest possible service life, the cells need to be mounted with some amount of pressure. Generally, the battery cells have a prismatic form and several cells are stacked together and electrically connected in an appropriate manner in order to form a battery. Here, constant pressure is generally applied on the two broad faces of the stacked battery cells. This pressure must be evenly distributed and also be compliant to the regular expansion cycles that the cells experience during the electric charge and discharge cycling and over a service life of the battery.

Additionally, the cells change in thickness over their life and over the load cycle, and the mechanical device to keep this load constant, must allow for compliance while maintaining constant pressure.

Currently, a mechanical arrangement is used to clamp a stack of alternately arranged battery cells (or battery pouches) and compliant foam material in order to evenly distribute the pressure. This arrangement is clamped between two outer plates using cross-bolts having sleeves located thereon that are between the plates to limit the maximum amount of compression that can be applied as the bolts and associated nuts are tightened. However, this arrangement does not allow for sensing of the applied load or for adjustment during the life of the battery pouch, as this will change over time.

### SUMMARY

An improved battery assembly is provided that addresses the issue with the prior art by providing that as the battery cells change in thickness over the life of the battery and over a load cycle, a constant pressure is applied to the battery cells while accommodating for the expansion.

In one arrangement, the battery assembly includes a plurality of cells and a mounting arrangement having two side plates, with the plurality of cells arranged between the two side plates with sides of the cells facing one another. At least two bolts extend between the side plates, with each bolt having a head on one end and a threaded engagement, such as a nut, on an opposite end. The at least two bolts are configured to clamp the side plates and the cells together. For each of the bolts, a diaphragm spring is located at least one of between the head and an adjacent one of the side plates or between the threaded engagement and an adjacent one of the side plates. The diaphragm spring is configured to apply a force over an effective range of the diaphragm spring such that a constant pressure is applied to the battery cells during expansion and contraction.

In one embodiment, the at least two bolts are installed between aligned holes in the two side plates, and each of the bolts includes a shoulder having a defined height under the head. The diaphragm spring for each of the bolts is located adjacent to the head, and the defined height sets a maximum compression for the diaphragm spring.

The shoulder can be integral with the bolt or provided as a separate spacer that is installed on each of the bolts.

In one embodiment, the diaphragm spring includes a plurality of fingers. Preferably, the fingers are uniformly spaced apart from each other and are arranged around a circumference of the diaphragm spring.

In the battery arrangement, the diaphragm springs are configured to apply a generally constant force over the effective range.

In one arrangement, pads are located between the sides of the cells that are facing one another. These can be for electrical insulation and/or provide heat removal paths.

In one arrangement, the diaphragm springs apply a constant force of between 4 and 20 PSI on the sides of the plurality of cells. However, the required force that is applied can be adapted to the particular type of battery cells.

In one embodiment, there are four of the bolts, and one of the diaphragm springs is located on each of the bolts. It is also possible to provide more than one diaphragm spring on each of the bolts, either arranged serially on one end, or at both ends.

In another aspect, a mounting arrangement for battery cells for maintaining a constant pressure over a duty cycle of the battery is provided. The mounting arrangement includes two side plates that are adapted to be arranged on outer sides of a plurality of stacked battery cells. At least two bolts extend between the side plates, with each bolt having a head on one end and a threaded engagement, such as a nut, on an opposite end. The at least two bolts being configured to clamp the side plates together. For each of the bolts, a diaphragm spring is located at least one of between the head and an adjacent one of the side plates or between the nut and an adjacent one of the side plates. The diaphragm spring is configured to apply a force to the plurality of stacked battery cells over an effective range of the diaphragm spring.

In one embodiment, the at least two bolts are installed between aligned holes in the two side plates, and each of the bolts includes a shoulder having a defined height under the head. The diaphragm spring for each of the bolts is located adjacent to the head, and the defined height sets a maximum compression for the diaphragm spring.

Here again, the shoulder can be provided integral with the bolt or can be provided as a separate spacer that is installed on each of the bolts.

The diaphragm spring can include a plurality of fingers, and in a preferred arrangement the fingers are uniformly spaced apart from each other and are arranged around a circumference of the diaphragm spring.

When installed, the diaphragm springs are configured to provide a generally constant force over the effective range.

In one arrangement, the diaphragm springs are configured to apply a constant force of between 4 and 20 PSI on the sides of the plurality of cells. However, the required force that is applied can be adapted to the particular type of battery cells.

In a preferred embodiment there are four of the bolts, and one of the diaphragm springs is located on each of the bolts.

It is also possible to provide more than one diaphragm spring on each of the bolts, either arranged serially on one end, or at both ends.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of a battery assembly according to a first embodiment.

FIG. 2 is an enlarged view showing a diaphragm spring arranged on a bolt used to clamp two side plates of the battery assembly shown in FIG. 1 together.

FIG. 3 is a cross-sectional view through a battery assembly showing two bolts extending between the side plates with a diaphragm spring located between each of the bolt heads and an adjacent ones of the side plates.

FIG. 4 is a detailed view of an exemplary embodiment of a diaphragm spring used in the battery assembly shown in FIG. 1.

FIG. 5 is a cross-sectional view taken along line 5-5 in FIG. 4.

FIG. 6 is a schematic view showing another embodiment of a bolt extending between two side plates of a battery assembly with a plurality of cells separated by pads located between the side plates.

FIG. 7 is a spring curve for an exemplary embodiment of the diaphragm spring.

### DETAILED DESCRIPTION OF THE PREFERRED EMBODIMENTS

Certain terminology is used in the following description for convenience only and is not limiting. A reference to a list of items that are cited as “at least one of a, b, or c” (where a, b, and c represent the items being listed) means any single one of the items a, b, or c, or combinations thereof. The terms “generally” and “approximately” mean within +/−10% of the indicated value. The terminology includes the words specifically noted above, derivatives thereof and words of similar import. The terms “cells” and “pouches” as used in connection with a battery construction are used synonymously.

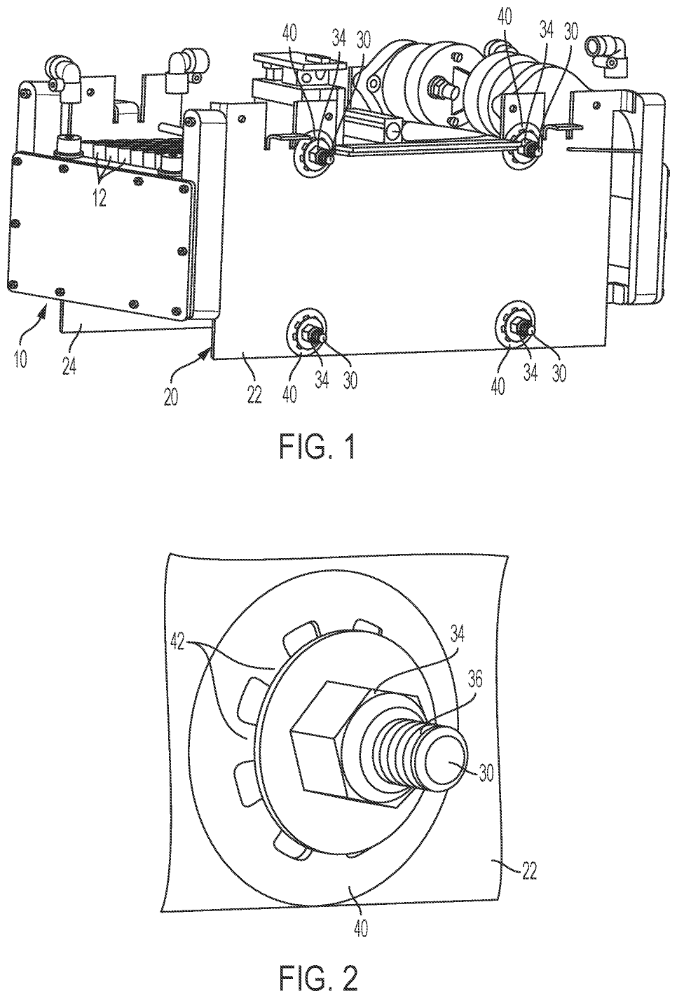

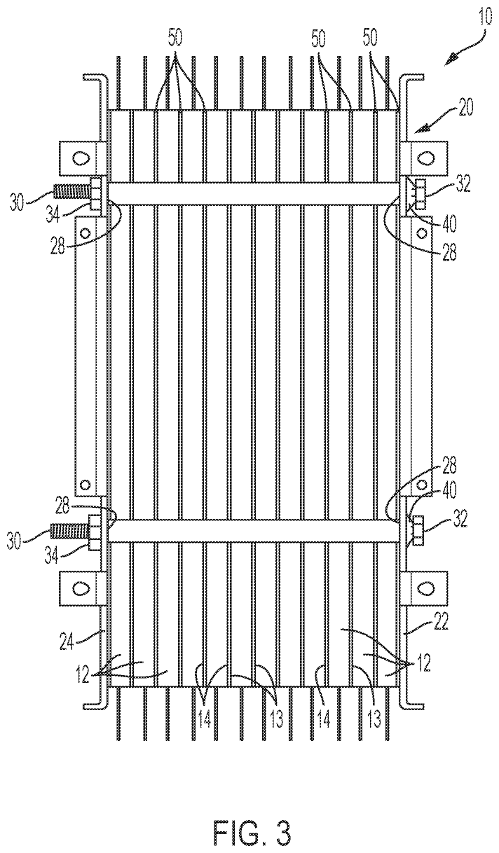

Referring to FIGS. 1-3, a battery assembly 10 according to a first embodiment is shown. The battery assembly 10 includes a plurality of cells 12, shown in detail in FIG. 3, which are held in a mounting arrangement 20.

As shown in FIG. 3, the mounting arrangement 20 includes two side plates 22, 24. The side plates 22, 24 are designed to maintain a load on the plurality of cells 12 arranged between the two side plates 22, 24. As shown in FIG. 3, the cells 12 are arranged with sides 13, 14 thereof facing one another. Here, it is possible to provide pads 50 located between the cells 12 that are facing one another. The pads 50 can be for electrical insulation and/or thermal conductivity for cooling purposes. However, the pads 50 are optional. These pads 50 can be made of various insulating materials that can be generally incompressible or optionally compressible, depending upon the specific battery assembly.

At least two bolts 30, shown in detail in FIG. 3, extend between the side plates 22, 24. Preferably, there are four of the bolts 30, and the bolts 30 are arranged to provide uniform loading on the side plates 22, 24. The bolts 30 each have a head 32 on one end and a nut 34, or other threaded engagement threadedly engaged with threads 36 on an opposite end. The at least two bolts 30 are configured to clamp side plates 22, 24 along with the plurality of cells 12 and optionally the pads 50 between them, together.

Still with reference to FIGS. 1-3, for each of the bolts 30, a diaphragm spring 40 is located at least one of between the head 32 and adjacent one of the side plates 22 or between the nut 34 or threaded engagement and an adjacent one of the side plates 34. FIGS. 1 and 2 show the diaphragm springs located between the side plates 24 and the nut 34, while FIG. 3 shows the diaphragm springs 40 located between the head 32 and the adjacent side plate 22. It is also possible for the diaphragm springs 40 to be located on both ends of the bolts 30, depending upon the particular application. It is also possible to have two or more of diaphragm springs 40 arranged on one end of the bolts 30, depending upon the specific load and expansion height being provided.

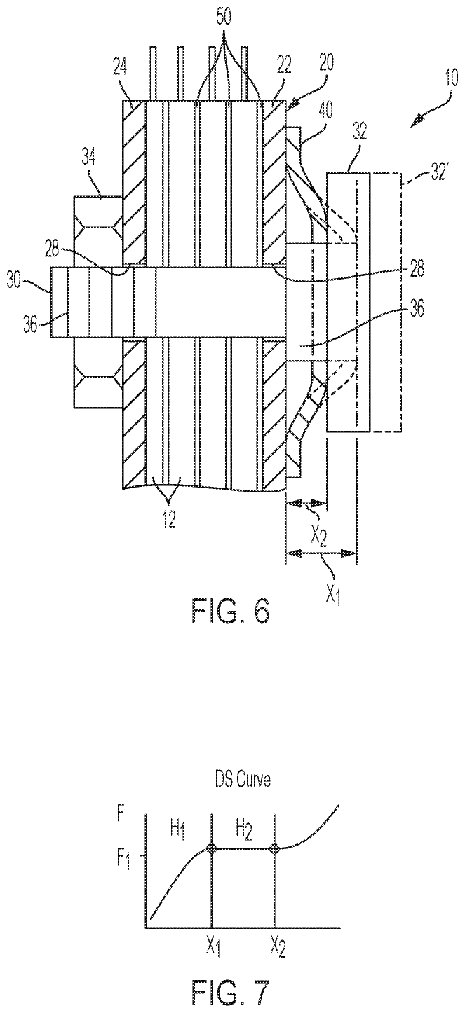

The diaphragm springs 40 are configured to apply a force over an effective range of the diaphragm spring 40. This effective range is illustrated in FIGS. 6 and 7 as X1-X2. The effective range is calculated to accommodate the expansion of the battery cells 12 during a duty cycle as well as over the life of the battery assembly 10.

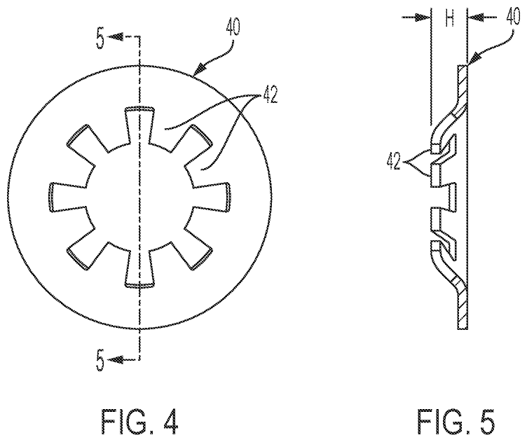

An exemplary embodiment of the diaphragm spring 40 is shown in FIGS. 4 and 5. Here, the diaphragm spring 40 includes a plurality of fingers 42. In a preferred arrangement, the fingers 42 are uniformly spaced apart from each other and are arranged around an inner circumference of the diaphragm spring 40. The diaphragm spring has an uncompressed height H. Preferably, the diaphragm spring 40 is made of hardened and tempered spring steel, although other suitable materials can be used as will be recognized by the person skilled in the art. In a preferred arrangement, the diaphragm spring 40 defines a generally constant force over the effective range. This force of each of the diaphragm springs 40 is calculated such that the force applied to the battery cells is in the range of 4-20 psi, and is applied on the sides 13, 14 of the cells 12. However, the specific force being applied can vary depending upon the particular battery type and configuration.

In order to ensure that the diaphragm springs 40 are maintained within the effective range, as shown in detail in FIG. 6, each of the bolts 30 may include a shoulder 38 having a defined height X2 under the head 32. The diaphragm spring 40 for each of the bolts 30 is located adjacent to the head 32, and the defined height X2 sets a maximum compression for the diaphragm spring 40. The diaphragm spring 40 is shown fully compressed in FIG. 6 in solid lines, and broken lines indicate there the diaphragm spring 40 would extend in its initial pre-loaded state based on the torque applied to the bolt 30 during installation.

As would be understood by those skilled in the art, the bolts 30 are preferably installed between aligned holes 28 in the side plates 22, 24 outside of an area of the cells 12. While four bolts 30 are preferred as shown in FIG. 1, the number of bolts 30 can vary depending upon the particular configuration of the battery assembly 10.

While the shoulder 38 can be provided integral with the bolt 30 as shown in FIG. 6, it may also be provided as a separate spacer that is installed on each of the bolts 30.

Referring to FIG. 7, a spring curve for the diaphragm spring 40 is shown. As can be seen in FIG. 7, when the diaphragm spring 40 is in its initial preloaded state (indicated in broken lines in FIG. 6) where the bolt head is in a position indicated in broken lines in FIG. 6 and marked as 32′ prior to the battery cells 12 expanding, the diaphragm spring 40 has a preload force F1 at the height H1 which corresponds to the distance X1 between the underside of the head 32 and the adjacent side plate 22. Either during a duty cycle or over the life of the battery assembly 10, the cells 12 expand. The maximum expansion is shown in FIG. 6 where the shoulder 38, contacts the side plate 22 at a distance X2, which corresponds to a compressed height 112 of the diaphragm spring 40.

As can be seen in FIG. 7, the spring characteristic of the diaphragm spring 40 provides for a generally constant force of F1 between the preload height H₁ and the maximum compressed height 112 which defines the effective range (X1-X2) of the diaphragm spring 40.

The mounting arrangement 20 including the side plates 22, 24, the bolts 30, and the diaphragm spring 40 can be provided as a kit for battery manufacture such that when assembled, the mounting arrangement 12 can be used to form the battery assembly 10, with the mounting arrangement 12 being configured to provide all of the properties noted above.

By providing the present arrangement in which the diaphragm spring 40 is tuned to provide a generally constant load with a variation in the overall stack height of the plurality of cells 12 which take place either during a duty cycle or over the life of the battery, higher performance can be achieved for the battery assembly 10 over a longer time frame as a generally constant pressure is maintained throughout the expansion and contraction cycles of the battery. Further, the maximum expansion of the battery assembly 10 over the life of the battery can be accommodated. This allows the peak performance of the battery assembly and the longest possible service life based on the generally constant evenly distributed pressure over the surfaces of the cells 12.

This arrangement also allows for the elimination of the previously used compression pads between the cells, allowing for a more compact battery assembly 10 in comparison with the prior known assemblies.

Having thus described the present disclosure in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

### LIST OF REFERENCE NUMERALS

10 Battery assembly
12 Cell
13 Side of cell
14 Side of cell
20 Mounting arrangement
22 Side plate
24 Side plate
28 Hole(s) in side plates
30 Bolt
32 Head
34 Nut
36 Spacer
40 Diaphragm Spring
42 Finger(s)
50 Pad

What is claimed is:

1. A battery assembly, comprising:
a plurality of cells;
a mounting arrangement including:
two side plates, with the plurality of cells arranged between the two side plates with sides of the cells facing one another;
at least two bolts extending between the side plates, each bolt having a head on one end and a threaded engagement on an opposite end, the at least two bolts being configured to clamp the side plates and the cells together; and
for each of the bolts, a diaphragm spring located at least one of between the head and an adjacent one of the side plates or between the nut and an adjacent one of the side plates, the diaphragm spring being configured to apply a force on the side plates over an effective range of the diaphragm spring.

2. The battery assembly of claim 1, wherein the at least two bolts are installed between aligned holes in the two side plates, and each of the bolts includes a shoulder having a defined height under the head, the diaphragm spring for each of the bolts is located adjacent to the head, and the defined height sets a maximum compression for the diaphragm spring.

3. The battery assembly of claim 2, wherein the shoulder is provided as a separate spacer that is installed on each of the bolts.

4. The battery assembly of claim 1, wherein the diaphragm spring includes a plurality of fingers.

5. The battery assembly of claim 4, wherein the plurality of fingers are uniformly spaced apart from each other and are arranged around a circumference of the diaphragm spring.

6. The battery assembly of claim 1, wherein the diaphragm springs are configured to apply a generally constant force over the effective range.

7. The battery assembly of claim 1, further comprising pads located between the sides of the cells that are facing one another.

8. The battery assembly of claim 1, wherein the diaphragm springs apply a generally constant force of between 4 and 20 PSI on the sides of the plurality of cells.

9. The battery assembly of claim 1, wherein there are four of the bolts, and one of the diaphragm springs is located on each of the bolts.

10. The battery assembly of claim 1, wherein two of the diaphragm springs are arranged on each of the bolts.

11. A mounting arrangement for battery cells for maintaining a constant pressure over a duty cycle of the battery, the mounting arrangement comprising:
two side plates that are adapted to be arranged on outer sides of a plurality of stacked battery cells;
at least two bolts extending between the side plates, each bolt having a head on one end and a threaded engagement on an opposite end, the at least two bolts being configured to clamp the side plates and the cells together; and
for each of the bolts, a diaphragm spring located at least one of between the head and an adjacent one of the side plates or between the nut and an adjacent one of the side plates, the diaphragm spring being configured to apply a constant force to the plurality of stacked battery cells over an effective range of the diaphragm spring.

12. The mounting arrangement of claim 11, wherein the at least two bolts are installed between aligned holes in the two side plates, and each of the bolts includes a shoulder having a defined height under the head, the diaphragm spring for each of the bolts is located adjacent to the head, and the defined height sets a maximum compression for the diaphragm spring.

13. The mounting arrangement of claim 12, wherein the shoulder is provided as a separate spacer that is installed on each of the bolts.

14. The mounting arrangement of claim 11, wherein the diaphragm spring includes a plurality of fingers.

15. The mounting arrangement of claim 14, wherein the plurality of fingers are uniformly spaced apart from each other and are arranged around a circumference of the diaphragm spring.

16. The mounting arrangement of claim 11, wherein the diaphragm springs are configured to apply a generally constant force over the effective range.

17. The mounting arrangement of claim 11, wherein the diaphragm springs are configured to apply a generally constant force of between 4 and 20 PSI on the sides of the plurality of cells.

18. The mounting arrangement of claim 11, wherein there are four of the bolts, and one of the diaphragm springs is located on each of the bolts.

19. The mounting arrangement of claim 11, wherein two of the diaphragm springs are arranged on each of the bolts.
